(19) United States
(12) Patent Application Publication
(10) Pub. No.: US 2025/0373173 A1
(43) Pub. Date: Dec. 4, 2025

(54) FLYBACK CONVERTER AND CONTROL CIRCUIT AND CONTROL METHOD THEREFOR

(71) Applicant: Joulwatt Technology Co., Ltd., Hangzhou (CN)

(72) Inventor: Yang YANG, Hangzhou (CN)

(21) Appl. No.: 19/227,111

(22) Filed: Jun. 3, 2025

(30) Foreign Application Priority Data
Jun. 4, 2024 (CN) 202410715202.8

(51) Int. Cl. H02M 3/335; H02M 1/00; H02M 1/44

(52) U.S. Cl. CPC H02M 3/33592; H02M 1/0058; H02M 1/44

(57) ABSTRACT

Disclosed is a flyback converter, a control circuit and a control method therefor. The control circuit includes: a primary-side control circuit for turning the main power transistor on and off; a secondary-side control circuit for turning the synchronous rectifier on and off, to turn on the synchronous rectifier for a first time period before a magnetizing current reaches the zero-crossing point for the first time, to turn on the synchronous rectifier for a second time period after the magnetizing current crosses zero. The secondary-side control circuit determines the second time period according to a preset volt-second reference and an output voltage of the flyback converter. An additional turn-on pulse width for the synchronous rectifier set by volt-second integration controls the negative magnetizing current, facilitating negative current sampling when zero voltage turn-on is performed, ensuring zero voltage turn-on to maximum extent across the full input voltage range to improve system efficiency.

### CROSS-REFERENCE TO PRIOR APPLICATIONS

The present application claims priority to Chinese Patent Application No. 202410715202.8, filed on Jun. 4, 2024, entitled “FLYBACK CONVERTER AND CONTROL CIRCUIT AND CONTROL METHOD THEREFOR”, the entire content of which is incorporated herein by reference, including the full text of the specification, claims, drawings, and abstract.

### TECHNICAL FIELD

The present disclosure relates to a technical field of switching power supplies, and in particular, to a flyback converter, and a control circuit and a control method therefor.

### BACKGROUND

A flyback converter is a commonly known power converter topology used to convert an input voltage to a desired output voltage. In conventional flyback converters, a switching transistor is typically turned on through voltage control or current control. However, conventional flyback converters may generate switching losses and electromagnetic interference when switching the switching transistor.

To reduce the impact caused by these issues, a novel flyback converter control technology, namely “zero voltage switching (ZVS)” technology, has been proposed. Based on this technology, additional reverse magnetization of the magnetizing inductor of the flyback converter can be performed, thus allowing the main power transistor to achieve zero voltage turn-on at the zero voltage moment after the synchronous rectifier transistor is turned off, that is, performing turn-on operation near the zero-crossing point of the voltage waveform, so that the turn-on loss on the switching transistor and the electromagnetic interference can be reduced.

By using zero voltage switching technology, flyback converters can achieve higher efficiency and reduced electromagnetic interference level, thereby improving the performance and reliability of the entire power supply system. This technology has been widely applied in many power supply applications and has significant development potential in future power converter designs.

### SUMMARY

To solve the above technical problems, the present disclosure provides a flyback converter, and a control circuit and a control method therefor, which are used to control the magnitude of a negative magnetizing current, thereby facilitating negative current sampling when zero voltage turn on is performed, and also ensuring zero voltage turn-on to the maximum extent across the full input voltage range to improve system efficiency.

According to a first aspect of the present disclosure, a control circuit for a flyback converter is provided. The flyback converter includes: a transformer, a main power transistor, and a synchronous rectifier transistor. The control circuit includes:
a primary-side control circuit, configured to control on and off states of the main power transistor;
a secondary-side control circuit, configured to control on and off states of the synchronous rectifier transistor, so as to control the synchronous rectifier transistor to operate in on state for a first time period before a magnetizing current of the flyback converter reaches a zero-crossing point for the first time, and to control the synchronous rectifier transistor to operate in on state for a second time period after the magnetizing current crosses zero,
wherein the secondary-side control circuit determines the second time period in accordance with a preset volt-second reference and an output voltage of the flyback converter. Optionally, the secondary-side control circuit is configured to:
when the synchronous rectifier transistor starts to operate in on state for the second time period, perform volt-second integration on the output voltage using an integration capacitor to obtain an integration signal, and determine the second time period in accordance with the integration signal and the volt-second reference.

Optionally, the volt-second reference has a preset value.

Optionally, the volt-second reference is set in accordance with a reference resistor, and the volt-second reference is positively correlated with a resistance value of the reference resistor.

Optionally, the secondary-side control circuit comprises:
a volt-second reference setting circuit, configured to set the volt-second reference in accordance with the reference resistor and a reference current;
an integration circuit, configured to perform volt-second integration on the output voltage using the integration capacitor when the synchronous rectifier transistor starts to operate in on state for the second time period, to obtain the integration signal;
a comparison circuit, having a first input terminal receiving the volt-second reference, and a second input terminal receiving the integration signal, the comparison circuit is configured to trigger and control the synchronous rectifier transistor to be turned off when the integration signal reaches the volt-second reference.

Optionally, the volt-second reference setting circuit comprises:
a reference resistor;
a volt-second reference conversion circuit, configured to provide the reference current, and convert the reference current in accordance with the reference resistor to generate the volt-second reference.

Optionally, during a period when the flyback converter is operated in boundary conduction mode (BCM mode), the secondary-side control circuit controls the synchronous rectifier transistor to start to operate in on state for the second time period when the magnetizing current crosses zero for the first time;

during a period when the flyback converter is operated in discontinuous conduction mode (DCM mode), at a valley moment of a drain-source voltage of the synchronous rectifier transistor after the magnetizing current crosses zero for the first time, the secondary-side control circuit controls the synchronous rectifier transistor to start to operate in on state for the second time period.

Optionally, the secondary-side control circuit is further configured to sample the output voltage to obtain feedback information, and transmit the feedback information to the primary-side control circuit through an isolation device without optocoupling;
the primary-side control circuit is configured to analyze the feedback information to obtain at least one of a control frequency of the flyback converter and a peak current reference of a primary-side current, so as to control on and off states of the main power transistor.

According to a second aspect of the present disclosure, a flyback converter is provided, and comprises: the control circuit according to any one of the embodiments of the present disclosure, wherein the control circuit is used to control on and off states of one or more switching transistor arranged in the flyback converter.

According to a third aspect of the present disclosure, a control method for a flyback converter is provided. The flyback converter includes: a transformer, a main power transistor, and a synchronous rectifier transistor. The control method includes:
after the main power transistor is turned off, controlling the synchronous rectifier transistor to operate in on state for a first time period before a magnetizing current of the flyback converter reaches a zero-crossing point for the first time;
after the magnetizing current crosses zero, controlling the synchronous rectifier transistor to operate in on state for a second time period, to allow the main power transistor to achieve zero voltage turn-on in a next switching cycle,
wherein the second time period is determined in accordance with a preset volt-second reference and an output voltage of the flyback converter.

Optionally, determining the second time period in accordance with the preset volt-second reference and the output voltage of the flyback converter comprises:
when the synchronous rectifier transistor starts to operate in on state for a second time period, performing volt-second integration on the output voltage using an integration capacitor to obtain an integration signal;
determining the second time period in accordance with the integration signal and the volt-second reference.

Optionally, the volt-second reference has a preset value.

Optionally, the volt-second reference is set in accordance with a reference resistor, and the volt-second reference is positively correlated with a resistance value of the reference resistor.

The present disclosure at least have following advantages:
the embodiment of the present disclosure controls the synchronous rectifier transistor to operate in on state for an additional pulse width (i.e., the second time period) after the magnetizing current of the flyback converter crosses zero, enabling additional reverse magnetization of the magnetizing inductor of the transformer and allowing the main power transistor to achieve zero voltage switching (ZVS) in a next switching cycle. Compared to conventional solutions, the embodiments of the present disclosure sets the second time period (i.e., the length of the additional turn-on pulse width), during which the synchronous rectifier transistor operates in on state, by means of volt-second integration. Therefore, the magnitude of the negative magnetizing current generated during reverse magnetization of the magnetizing inductor of the transformer can be controlled, thereby facilitating negative current sampling when zero voltage turn-on is performed. Meanwhile, the volt-second setting method can also ensure zero voltage turn-on to the maximum extent across the full input voltage range, optimizing ZVS effect under different input and output voltages, and improving system efficiency.

It should be noted that the above general description and the following detailed description are merely exemplary and explanatory and are not restrictive of the present disclosure.

### BRIEF DESCRIPTION OF THE DRAWINGS

FIG. 1 shows a schematic diagram of an example of a flyback converter according to an embodiment of the present disclosure;

FIG. 2 shows a schematic diagram of an example of a secondary-side control chip in the secondary-side control circuit according to an embodiment of the present disclosure;

FIG. 3 shows a signal waveform diagram of the flyback converter which is shown in FIG. 1 and operated in DCM mode;

FIG. 4 shows a signal waveform diagram of the flyback converter which is shown in FIG. 1 and operated in BCM mode;

FIG. 5 shows a schematic diagram of an example of the secondary-side control circuit in FIG. 1;

FIG. 6 shows a flowchart of a control method for a flyback converter according to an embodiment of the present disclosure.

### DETAILED DESCRIPTION

To facilitate understanding of the present disclosure, the present disclosure will be described more comprehensively with reference to the relevant drawings. The preferred embodiments of the present disclosure are given in the drawings. However, the present disclosure can be implemented in different forms and is not limited to the embodiments described herein. Rather, the provision of these embodiments is to make the disclosure of the present disclosure more thorough and comprehensive.

In the description of the present specification, references to “an embodiment” or “some embodiments” mean that a particular feature, structure, or characteristic described in connection with the embodiment is included in at least one embodiment of the present disclosure. Therefore, the appearances of the phrases “in one embodiment”, “in some embodiments”, “in other embodiments”, “in further embodiments”, etc., in various places in the present specification are not necessarily all referring to the same embodiment, but rather mean “one or more but not all embodiments”, unless otherwise specifically emphasized. The terms “comprising”, “including”, “having”, and their variations mean “including but not limited to”, unless otherwise specifically emphasized.

In addition, the terms “exemplary” or “for example” are used to represent examples, illustrations, or explanations. Any embodiment described as “exemplary” or “for example” in the present disclosure should not be construed as being preferred or more advantageous than other embodiments. The term “and/or” is a description of the association relationship of associated objects, indicating that there may be three types of relationships, for example, A and/or B can mean: A alone, A and B together, B alone. “Multiple” means two or more than two. Furthermore, to clearly describe the technical solutions of the embodiments of the present disclosure, the terms “first”, “second”, etc., are used to distinguish items or similar items with basically the same function and effect. Those skilled in the art can understand that the terms “first”, “second”, etc., do not limit quantity and execution order, and the terms “first”, “second”, etc., do not necessarily mean different.

Furthermore, in the drawings, the same reference numerals indicate the same or similar structures, and thus their repeated descriptions are omitted, that is, each part of the present specification is described in a parallel and progressive manner, and each part focuses on the differences from other parts, and the same or similar parts between each part can be referred to each other.

For switching power supplies with wide input range and wide output range, in related technical solutions, the main approach for achieving better ZVS effect on the main power transistor is to collect the input voltage information and the output voltage information of the system, first perform open-loop fitting to obtain a curve of the additional turn-on pulse width fo the synchronous rectifier transistor, and then perform closed-loop controlling on the additional turn-on pulse width for the synchronous rectifier transistor to achieve real-time compensation, so as to confirm that the additional turn-on pulse width for the synchronous rectifier transistor has achieved an optimal ZVS effect. However, the additional turn-on pulse width for the synchronous rectifier transistor obtained by the open-loop fitting may introduce relatively large error, causing poor adaptability, and the negative magnetization is not uniform, which is not conducive to the development of an isolation product without optocoupling; the real-time compensation method for the closed-loop adjustment needs a complex control process with a dynamic adjustment process, and may have dynamic adjustment speed matching issue.

To address the above problems, the embodiments of the present disclosure disclose a new flyback converter control solution, which is mainly achieved by setting the additional turn-on pulse width for the synchronous rectifier transistor by means of volt-second integration, without the need for performing open-loop fitting and closed-loop adjustment operations, thus, not only the magnitude of the negative magnetizing current can be controlled, but also the zero voltage turn-on can be achieved to the maximum extent across the full input voltage range, thus ensuring high adaptability, and also improving system efficiency. In addition, this control solution can be applied to isolation topologies without optocoupling, facilitating the development of isolation products without optocoupling.

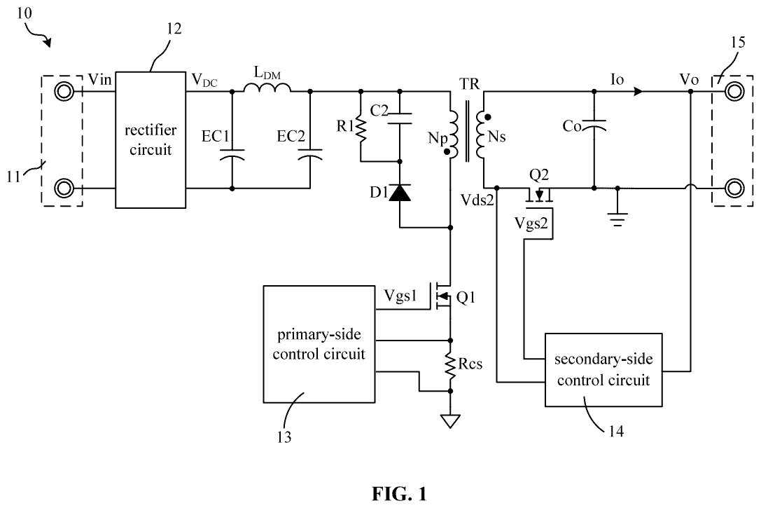

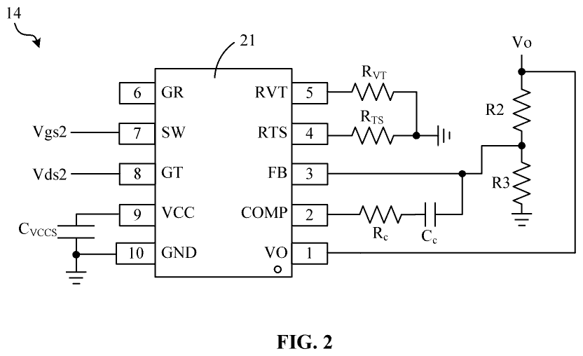

FIG. 1 shows a schematic diagram of an example of a flyback converter according to an embodiment of the present disclosure, FIG. 2 shows a schematic diagram of an example of a secondary-side control chip in a secondary-side control circuit according to an embodiment of the present disclosure, and the isolation-type switching converter shown in FIG. 1 is a typical flyback converter topology. It should be noted that this is only an example, and the control scheme according to the present disclosure can also be applied to other isolation-type switching converters, such as forward, flyback, full-bridge, or push-pull topologies, etc.

In the example shown in FIG. 1, the flyback converter 10 includes: a transformer TR including a primary winding Np and a secondary winding Ns, a voltage input circuit and a main power transistor Q1 which are connected to the primary winding Np, a voltage output circuit and a synchronous rectifier transistor Q2 which are connected to the secondary winding Ns, and a control circuit.

In the example shown in FIG. 1, the voltage input circuit includes a rectifier circuit 12, a capacitor EC1, a capacitor EC2, an inductor LDM, and an energy recovery circuit (e.g., including a resistor R1, a capacitor C2, and a diode D1). The rectifier circuit 12 is coupled between a power input port 11 of the flyback converter 10 and the primary winding Np; the capacitor EC1, the capacitor EC2 and the inductor LDM are coupled between the rectifier circuit 12 and the primary winding Np; and the energy recovery circuit is coupled between the homonymous end and the heteronymous end of the primary winding Np. The capacitor EC1, the capacitor EC2, and the inductor LDM are used to perform functions, such as filtering the output signal of the rectifier circuit 12 and calibrating power factor, etc. Of course, other implementations are also possible, for example, in some other embodiments, the aforementioned filtering function and power factor calibration function can also be achieved using other common filtering circuits and power factor calibration circuits, which are not strictly limited herein.

The voltage output circuit includes a capacitor Co coupled between the secondary winding Ns and an output port 15 of the flyback converter 10. The output port 15 is used to couple to a load, so as to allow the load to receive the electrical energy (e.g., voltage and current) converted by the flyback converter 10. In some examples, the electrical energy converted by the flyback converter 10 may also pass through a filter before being supplied to the load.

The main power transistor Q1 and the sampling resistor Rcs are connected in series between the primary winding Np and the reference ground, and the synchronous rectifier transistor Q2 is coupled between the secondary winding Ns and the voltage output circuit. In one possible embodiment, the main power transistor Q1 and the synchronous rectifier transistor Q2, for example, are implemented by NMOS field-effect transistors. In some other examples, the flyback converter 10 may be provided without the sampling resistor Rcs.

The control circuit includes a primary-side control circuit 13 and a secondary-side control circuit 14. In some examples, the primary-side control circuit 13 is coupled to the control terminal of the main power transistor Q1 and the sampling resistor Rcs, respectively, and provides a drive signal Vgs1 to the control terminal of the main power transistor Q1 according to the secondary-side feedback information and the primary-side current information which is obtained by sampling, to control the on and off states of the main power transistor Q1 using the drive signal Vgs1. The secondary-side control circuit 14 is coupled to the control terminal of the synchronous rectifier transistor Q2, the drain of the synchronous rectifier transistor Q2, and the output terminal of the flyback converter 10, respectively, and provides a drive signal Vgs2 to the control terminal of the synchronous rectifier transistor Q2 according to the output voltage Vo of the flyback converter 10 and the drain-source voltage Vds2 of the synchronous rectifier transistor Q2 to control the on and off states of the synchronous rectifier transistor Q2.

In this embodiment, the flyback converter 10 mainly operates by performing a control method using the secondary side as master, for example, the secondary-side control circuit 14 is configured to sample the output voltage Vo to obtain the feedback information required for primary-side control, and transmit the feedback information to the primary-side control circuit 13 in pulse form through an isolation device (e.g., such as the transformer TR) without optocoupling. The primary-side control circuit 13 is configured to receive and analyze the feedback information transmitted by the secondary side to obtain at least one of the control frequency of the flyback converter and the peak current reference of the primary-side current (denoted as Ip), and control the on and off states of the main power transistor Q1 accordingly. The specific structure and operating principle of the primary-side control circuit 13 can be understood with reference to conventional technical solutions, which are not detailed herein.

In some examples, the secondary-side control circuit 14, for example, obtains an error compensation signal (denoted as signal comp) according to the output voltage Vo and a preset voltage reference, and generates a pulse signal representing the feedback information according to the signal comp. The specific principle can be understood with reference to related conventional technical solutions, which are not detailed herein.

The secondary-side control circuit 14 is configured to control the synchronous rectifier transistor Q2 to operate in on state for a first time period before the magnetizing current of the flyback converter reaches a zero-crossing point for the first time (including the zero-crossing moment when the zero-crossing point is reached for the first time), and to control the synchronous rectifier transistor Q2 to operate in on state for a second time period (denoted as t_{w}) after the magnetizing current crosses zero (e.g., after the magnetizing current crosses zero for the first time, including the zero-crossing moment when the zero-crossing point is reached for the first time). In this embodiment, the synchronous rectifier transistor Q2 is controlled to operate in on state for the second time period t_{w} after the magnetizing current crosses zero, by a small pulse turn-on control method. During the second time period t_{w} when the synchronous rectifier transistor Q2 operates in on state, the magnetizing inductor (denoted as Lp, for example, provided by the primary winding Np of the transformer TR) of the flyback converter 10 is subjected to additional reverse magnetization, i.e., generating a negative magnetizing current, and allowing the main power transistor Q1 to achieve zero voltage turn-on at the zero voltage moment after the synchronous rectifier transistor Q2 is turned off.

It should be noted that in this embodiment, the zero-crossing moment (e.g., the first zero-crossing moment) of the magnetizing current of the flyback converter can be regarded as the critical moment for on-off switching of the synchronous rectifier transistor Q2. The state of the synchronous rectifier transistor Q2 at this moment can be regarded as the on state or the off state, and specific reference judgment can be assisted by the current operating mode of the flyback converter.

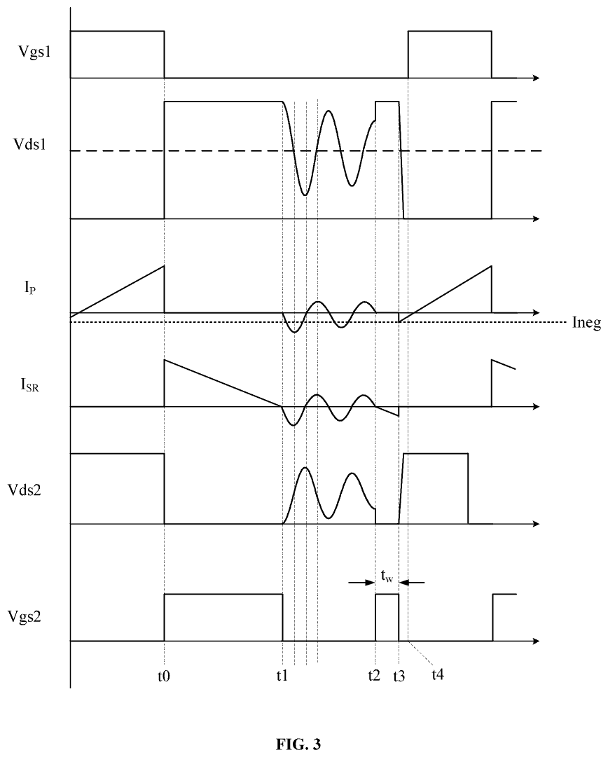

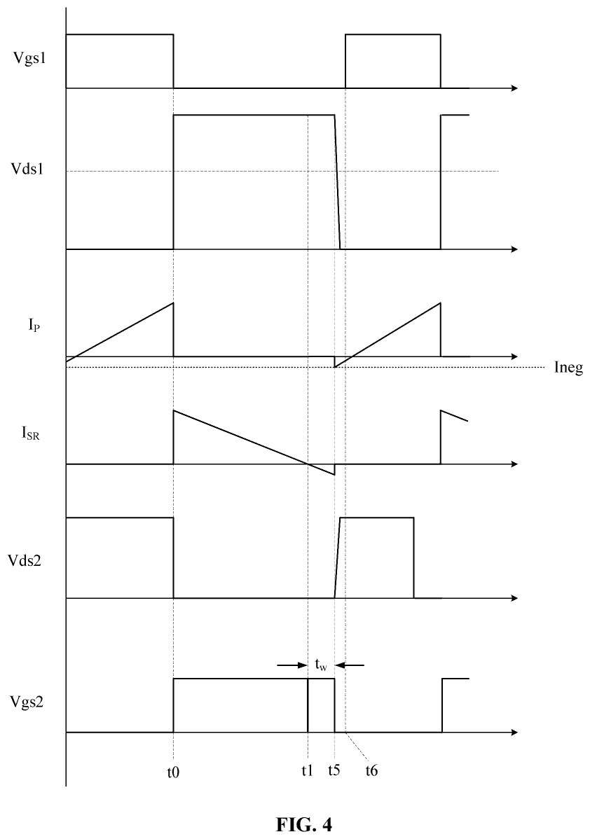

Referring to FIG. 3 and FIG. 4, FIG. 3 shows a signal waveform diagram of the flyback converter shown in FIG. 1 in DCM mode, and FIG. 4 shows a signal waveform diagram of the flyback converter shown in FIG. 1 in BCM mode. In these embodiments, the secondary-side control circuit 14 is configured to control the synchronous rectifier transistor Q2 to be turned on at time to. When the first zero-crossing moment (e.g., time t1) of the magnetizing current is reached, it indicates that the synchronous rectifier transistor Q2 has been operated in on state for the first time period (corresponding to the time period t0-t1). At the same time, the secondary-side control circuit 14 is configured to determine the start moment for controlling the synchronous rectifier transistor Q2 to operate in on state for the additional second time period t_{w} according to the operating mode of the flyback converter 10. For example, when it is detected that the flyback converter 10 is operating in BCM mode (which may be also referred to as critical conduction mode, i.e., CRM mode), the secondary-side control circuit 14 controls the synchronous rectifier transistor Q2 to start to operate in on state for the additional second time period t_{w} at the first zero-crossing moment (e.g., time t1) of the magnetizing current, as shown in FIG. 4. turn-off operation may not be performed on the synchronous rectifier transistor Q2 at this moment, instead, the turn-off operation may be performed on the synchronous rectifier transistor Q2 with a delay; when it is detected that the flyback converter 10 is operating in DCM mode, the secondary-side control circuit 14 controls the synchronous rectifier transistor Q2 to start to operate in on state for the additional second time period t_{w} at the valley moment (e.g., time t2) of the drain-source voltage Vds2 of the synchronous rectifier transistor after the first zero-crossing moment of the magnetizing current, as shown in FIG. 3. It can be understood that since both time t1 and time t2 are moments when the current flowing through the magnetizing inductor is zero, it can ensure that the initial state of the magnetizing inductor can be unified to be zero, which can improve the control accuracy of the flyback converter 10.

In this embodiment, the secondary-side control circuit 14 determines the second time period t_{w} according to a preset volt-second reference (denoted as V_{RTS}) and the output voltage Vo of the flyback converter. In some implementations, the secondary-side control circuit 14 is configured to perform volt-second integration on the output voltage Vo using an integration capacitor when the synchronous rectifier transistor Q2 starts to operate in on state for the second time period t_{w} to obtain an integration signal, and determine the second time period t_{w} according to the integration signal and the volt-second reference V_{RTS}.

In other words, under the situation that the start time of the additional second time period t_{w} for the synchronous rectifier transistor Q2 is determined according to the operating mode of the flyback converter 10, the secondary-side control circuit 14 determines the end time of the additional second time period t_{w} for the synchronous rectifier transistor Q2, and determining the end time of the additional second time period t_{w} for the synchronous rectifier transistor Q2 according to the integration signal and the volt-second reference V_{RTS}.

In some preferred embodiments, the aforementioned volt-second reference V_{RTS} is a preset value. In a specific implementation, the volt-second reference V_{RTS} can be set according to a reference resistor (denoted as R_{TS}), and the volt-second reference V_{RTS} is positively correlated with the resistance value of the reference resistor R_{TS}.

Referring to FIG. 2, in some embodiments, the secondary-side control circuit 14 includes a secondary-side control chip 21, and resistors and capacitors coupled to the corresponding pins of the secondary-side control chip 21. In an example as shown in FIG. 2, the secondary-side control chip 21 includes but is not limited to: pin VO, pin COMP, pin FB, pin RTS, pin RVT, pin GR, pin SW, pin GT, pin VCC, and pin GND, wherein the pin VO is coupled to the output terminal of the flyback converter 10; the pin COMP is coupled to the output terminal of the flyback converter 10 through a resistor R_{C}, a capacitor C_{C}, and a resistor R2 in sequence; the pin FB is coupled to the output terminal of the flyback converter 10 through a resistor R2, and coupled to the reference ground through a resistor R3; the pin R_{TS} is coupled to the reference ground through the resistor R_{TS}; the pin RVT is coupled to the reference ground through a resistor R_{VT}; the pin SW is coupled to the gate of the synchronous rectifier transistor Q2; the pin GT is coupled to the drain of the synchronous rectifier transistor Q2; the pin VCC is coupled to the pin GND through a capacitor C_{VCCS}. It should be noted that the pin layout of the secondary-side control chip 21 shown in FIG. 2 is only exemplary, and in practical applications, the secondary-side control chip 21 can also use other pin layout schemes, which are not strictly limited in this embodiment.

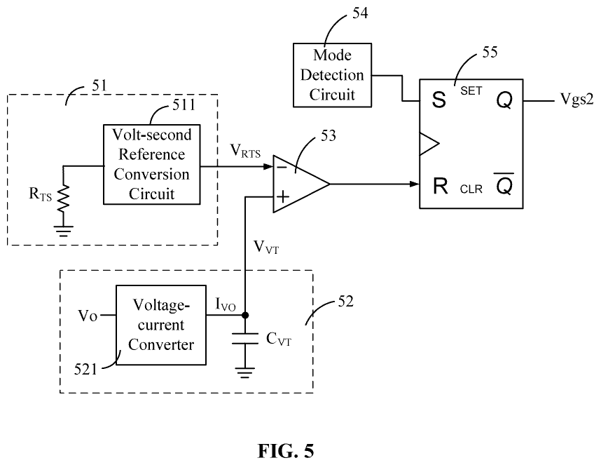

FIG. 5 shows a schematic diagram of an example of the secondary-side control circuit in FIG. 1. In an example as shown in FIG. 5, the secondary-side control circuit 14 includes: a volt-second reference setting circuit 51, an integration circuit 52, a comparison circuit 53, a mode detection circuit 54, and an RS flip-flop 55. The volt-second reference setting circuit 51 is used to set the volt-second reference V_{RTS} according to the reference resistor R_{TS} and the reference current (denoted as I_{RTS}). When the synchronous rectifier transistor Q2 starts to operate in on state for the second time period, the integration circuit 52 is configured to perform volt-second integration on the output voltage Vo using the integration capacitor C_{VT} to obtain the integration signal V_{VT}. The first input terminal of the comparison circuit 53 receives the volt-second reference V_{RTS}, and the second input terminal of the comparison circuit 53 receives the integration signal V_{VT}. The comparison circuit 53 is configured to output a ZVS turn-off trigger signal when the integration signal V_{VT} reaches the volt-second reference V_{RTS}, to trigger and control the synchronous rectifier transistor Q2 to be turned off. The mode detection circuit 54 is used to detect the operating mode of the flyback converter 10 and determine the start time of the additional second time period t_{w} for the synchronous rectifier transistor Q2 according to different operating modes. The set terminal of the RS flip-flop 55 is coupled to the output terminal of the mode detection circuit 54, the reset terminal of the RS flip-flop 55 is coupled to the output terminal of the comparison circuit 53, and the output terminal of the RS flip-flop 55 is coupled to the control terminal of the synchronous rectifier transistor Q2 directly or through a buffer.

In some embodiments, the volt-second reference setting circuit 51 further includes: the reference resistor R_{TS} and a volt-second reference conversion circuit 511, wherein the volt-second reference conversion circuit 511 includes but is not limited to a current source providing the reference current I_{RTS}. The volt-second reference conversion circuit 511 is used to convert the reference current I_{RTS} in accordance to the reference resistor R_{TS} to generate the volt-second reference V_{RTS}.

In some embodiments, the integration circuit 52 further includes: a voltage-current converter 521 and an integration capacitor C_{VT}. The input terminal of the voltage-current converter 521 receives the output voltage Vo, and the output terminal of the voltage-current converter 521 outputs a current signal Ivo corresponding to the output voltage Vo. The integration capacitor C_{VT} is coupled between the output terminal of the voltage-current converter 521 and the reference ground, and is used to perform volt-second integration according to the current signal Ivo to obtain the integration signal V_{VT}. Of course, the integration circuit 52 also includes a switching transistor (not shown) for controlling the start and the end of volt-second integration, and a switching transistor (not shown) for resetting the voltage across the integration capacitor C_{VT}.

Referring to FIG. 3 and FIG. 4, FIG. 3 shows a signal waveform diagram of the flyback converter shown in FIG. 1 in DCM mode, and FIG. 4 shows a signal waveform diagram of the flyback converter shown in FIG. 1 in BCM mode. Combining FIG. 3, FIG. 4, and FIG. 5, the operating principle of the secondary-side control circuit 14 can be described as follows:
at time t0, the secondary-side control circuit 14 controls the synchronous rectifier transistor Q2 to be turned on.

When the synchronous rectifier transistor Q2 operates in on state, the mode detection circuit 54 detects the operating mode of the flyback converter 10. When it is detected that the flyback converter 10 is operating in BCM mode, volt-second integration is performed on the current signal Ivo of the output voltage Vo using the integration capacitor C_{VT} from the first zero-crossing moment (time t1) of the magnetizing current, and the synchronous rectifier transistor Q2 is controlled to be turned off when the integration signal V_{VT} reaches the volt-second reference V_{RTS} (e.g., at time t5), which is equivalent to controlling the synchronous rectifier transistor Q2 to be turned off after a delay of the second time period t_{w} (corresponding to the time period t1-t5) in one switching cycle; when it is detected that the flyback converter 10 is operating in DCM mode, the synchronous rectifier transistor Q2 is controlled to be turned off for the first time at the first zero-crossing moment (time t1) of the magnetizing current, and the valley moment (e.g., time t2) of the drain-source voltage Vds2 of the synchronous rectifier transistor after the first zero-crossing moment of the magnetizing current is detected, and from this valley moment (time t2), volt-second integration is performed on the the current signal Ivo of the output voltage Vo using the integration capacitor C_{VT}, and the synchronous rectifier transistor Q2 is controlled to be turned off for the second time when the integration signal V_{VT} reaches the volt-second reference V_{RTS} (e.g., time t3), which is equivalent to controlling the synchronous rectifier transistor Q2 to be turned on twice in one switching cycle, and the second turn-on time is the second time period t_{w} (corresponding to the time period t2-t3).

In this embodiment, the setting of the volt-second reference V_{RTS} satisfies the following conditions:

$$\frac{1}{2} * {L}_{p} * {I}_{ner}^{2} = \frac{1}{2} * {C}_{eq} * {V}_{D C}^{2} \qquad ( 1 )$$

$${L}_{p} * {I}_{neg} = {N}_{p s} * {V}_{o} * {t}_{w} , \qquad ( 2 )$$

where Lp represents the magnetizing inductance of the magnetizing inductor, Ineg represents an average value of the negative magnetizing current, Ceq represents the equivalent capacitance at an intermediate connecting node between the main power transistor Q1 and the primary winding Np, including but not limited to the parasitic capacitance between the drain and the source of the main power transistor Q1, VDC represents the DC bus voltage output by the rectifier circuit 11, Nps represents the turns ratio between the primary winding and the secondary winding of the transformer TR, Vo represents the output voltage, and t_{w} represents the additional turn-on pulse width (i.e., the second time period) for the synchronous rectifier transistor Q2.

From equations (1) and (2), it can be concluded that in the case where the magnetizing inductance Lp of the flyback converter 10 is determined, when the volt-second reference V_{RTS} is set to a preset value (e.g., a fixed value), the negative magnetizing current corresponding to the magnetizing inductance Lp is consistent, i.e., when the volt-second reference V_{RTS} is set to a preset value, the corresponding negative magnetizing energy is fixed, and at this time, the primary-side main power transistor Q1 can achieve ZVS under a certain DC bus voltage VDC (or input voltage Vin). Therefore, in some preferred examples, the volt-second reference V_{RTS} can be designed under the highest input voltage Vin, i.e., the maximum DC bus VDC, so as to allow the main power transistor Q1 to achieve ZVS across the full input voltage range.

According to the embodiments of the present disclosure, the additional turn-on pulse width (i.e., the second time period t_{w}) for the synchronous rectifier transistor can be set by means of volt-second integration, which can not only control the magnitude of the negative magnetizing current, but also achieve zero voltage turn-on to the maximum extent across the full input voltage range, which is conducive to improving system efficiency, and the circuit structure is simple to be implemented.

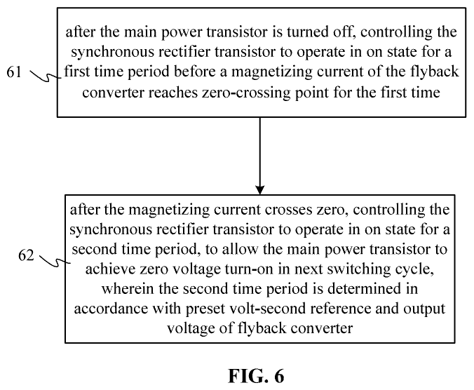

Furthermore, an embodiment of the present disclosure also provides a control method for a flyback converter, which can be applied to the flyback converter 10 as shown in any of the aforementioned embodiments. As shown in FIG. 6, the control method includes executing the following steps:

In step 61, after the main power transistor is turned off, the synchronous rectifier transistor is controlled to operate in on state for a first time period before the magnetizing current of the flyback converter reaches a zero-crossing point for the first time.

In this step, the method for controlling the synchronous rectifier transistor to operate in on state for the first time period before the magnetizing current of the flyback converter reaches zero can be implemented with reference to related conventional technical solutions. For example, the synchronous rectifier transistor can be turned on after a predetermined dead time after the main power transistor is turned off, and the synchronous rectifier transistor can be set to operate in on state for the first time period which is a fixed time period, or the synchronous rectifier transistor can be controlled to operate in on state until the first zero-crossing moment of the magnetizing current of the flyback converter is reached, and this turn-on time period can serve as the first time period, etc.

In step 62, after the magnetizing current crosses zero, the synchronous rectifier transistor is controlled to operate in on state for a second time period, to allow the main power transistor to achieve zero voltage turn-on in the next switching cycle, wherein the second time period is determined according to a preset volt-second reference and the output voltage of the flyback converter.

In this step, the method for determining the second time period according to the preset volt-second reference and the output voltage of the flyback converter includes: when the synchronous rectifier transistor starts to operate in on state for the second time period, performing volt-second integration on the output voltage using an integration capacitor to obtain an integration signal; determining the second time period according to the integration signal and the volt-second reference. For example, the time required for the integration signal to reach the preset volt-second reference from an initial potential state (e.g., zero potential) can serve as the second time period, which is equivalent to controlling the synchronous rectifier transistor to be turned off when the integration signal reaches the volt-second reference.

In some preferred examples, the preset volt-second reference is a preset value. In a specific implementation, the volt-second reference is set according to a reference resistor, and the volt-second reference is positively correlated with the resistance value of the reference resistor.

It should be noted that in a specific implementation, the specific implementation and the technical effects that can be obtained in the steps of the control method for the flyback converter as described above can be referred to the aforementioned embodiments of the flyback converter, which are not repeated here.

In summary, according to the embodiments of the present disclosure, the synchronous rectifier transistor is controlled to operate in on state for an additional pulse width (i.e., the second time period) after the magnetizing current of the flyback converter crosses zero, enabling the magnetizing inductor of the transformer to perform additional reverse magnetization and allowing the main power transistor to achieve zero voltage switching (ZVS) in the next switching cycle. Compared to conventional solutions, the embodiment of the present disclosure sets the second time period (i.e., the length of the additional turn-on pulse width), during which the synchronous rectifier transistor operates in on state, by means of volt-second integration. Therefore, the magnitude of the negative magnetizing current generated during the reverse magnetization of the magnetizing inductor of the transformer can be controlled, thereby facilitating negative current sampling when zero voltage turn-on is performed. Meanwhile, the volt-second setting method can also ensure zero voltage turn-on to the maximum extent across the full input voltage range, optimizing the ZVS effect under different input and output voltages, and improving system efficiency.

Finally, it should be noted that the above embodiments are merely examples for clearly illustrating the present disclosure and are not intended to limit the implementation methods. For those skilled in the art, other different forms of changes or modifications can be made in accordance with the above description. It is not necessary to exhaust all implementation methods here. The obvious changes or modifications derived from this are still within the protection scope of the present disclosure.

What is claimed is:

1. A control circuit for a flyback converter, wherein the flyback converter comprises a transformer, a main power transistor, and a synchronous rectifier transistor, and the control circuit comprises:
a primary-side control circuit, configured to control on and off states of the main power transistor;
a secondary-side control circuit, configured to control on and off states of the synchronous rectifier transistor, so as to control the synchronous rectifier transistor to operate in on state for a first time period before a magnetizing current of the flyback converter reaches a zero-crossing point for the first time, and to control the synchronous rectifier transistor to operate in on state for a second time period after the magnetizing current crosses zero,
wherein the secondary-side control circuit is further configured to determine the second time period in accordance with a preset volt-second reference and an output voltage of the flyback converter.

2. The control circuit according to claim 1, wherein the secondary-side control circuit is configured to:
when the synchronous rectifier transistor starts to operate in on state for the second time period, perform volt-second integration on the output voltage using an integration capacitor to obtain an integration signal, and determine the second time period in accordance with the integration signal and the volt-second reference.

3. The control circuit according to claim 2, wherein the volt-second reference is set in accordance with a reference resistor, and the volt-second reference is positively correlated with a resistance value of the reference resistor.

4. The control circuit according to claim 3, wherein the secondary-side control circuit comprises:
a volt-second reference setting circuit, configured to set the volt-second reference in accordance with the reference resistor and a reference current;
an integration circuit, configured to perform volt-second integration on the output voltage using the integration capacitor to obtain the integration signal when the synchronous rectifier transistor starts to operate in on state for the second time period;
a comparison circuit, having a first input terminal receiving the volt-second reference, and a second input terminal receiving the integration signal, wherein the comparison circuit is configured to trigger and control the synchronous rectifier transistor to be turned off when the integration signal reaches the volt-second reference.

5. The control circuit according to claim 4, wherein the volt-second reference setting circuit comprises:
a reference resistor;
a volt-second reference conversion circuit, configured to provide the reference current, and convert the reference current in accordance with the reference resistor to generate the volt-second reference.

6. The control circuit according to claim 2, wherein,
during a period when the flyback converter is operated in boundary conduction mode, the secondary-side control circuit controls the synchronous rectifier transistor to start to operate in on state for the second time period when the magnetizing current crosses zero for the first time;
during a period when the flyback converter is operated in discontinuous conduction mode, at a valley moment of a drain-source voltage of the synchronous rectifier transistor after the magnetizing current crosses zero for the first time, the secondary-side control circuit controls the synchronous rectifier transistor to start to operate in on state for the second time period.

7. The control circuit according to claim 1, wherein the secondary-side control circuit is further configured to sample the output voltage to obtain feedback information, and transmit the feedback information to the primary-side control circuit through an isolation device without optocoupling;
the primary-side control circuit is configured to analyze the feedback information to obtain at least one of a control frequency of the flyback converter and a peak current reference of a primary-side current, so as to control on and off states of the main power transistor.

8. A flyback converter, comprising: the control circuit according to claim 1, the transformer, the main power transistor, and the synchronous rectifier transistor,
wherein the control circuit is used to control on and off states of one or more switching transistor arranged in the flyback converter.

9. A control method for a flyback converter, the flyback converter comprising a transformer, a main power transistor, and a synchronous rectifier transistor, wherein the control method comprises:
after the main power transistor is turned off, controlling the synchronous rectifier transistor to operate in on state for a first time period before a magnetizing current of the flyback converter reaches a zero-crossing point for the first time;
after the magnetizing current crosses zero, controlling the synchronous rectifier transistor to operate in on state for a second time period, to allow the main power transistor to achieve zero voltage turn-on in a next switching cycle,
wherein the second time period is determined in accordance with a preset volt-second reference and an output voltage of the flyback converter.

10. The control method according to claim 9, wherein determining the second time period in accordance with the preset volt-second reference and the output voltage of the flyback converter comprises:
when the synchronous rectifier transistor starts to operate in on state for the second time period, performing volt-second integration on the output voltage using an integration capacitor to obtain an integration signal;
determining the second time period in accordance with the integration signal and the volt-second reference.

11. The control method according to claim 9, wherein the volt-second reference is set in accordance with a reference resistor, and the volt-second reference is positively correlated with a resistance value of the reference resistor.
